(19) United States
(12) Patent Application Publication
(10) Pub. No.: US 2020/0266046 A1
(43) Pub. Date: Aug. 20, 2020

(54) MASS SPECTROMETER

(71) Applicant: SHIMADZU CORPORATION, Kyoto-shi (JP)

(72) Inventors: Osamu FURUHASHI, Kyoto-shi (JP); Junichi TANIGUCHI, Kyoto-shi (JP); Kiyoshi OGAWA, Kyoto-shi (JP)

(73) Assignee: SHIMADZU CORPORATION, Kyoto-shi (JP)

(21) Appl. No.: 16/738,129

(22) Filed: Jan. 9, 2020

(30) Foreign Application Priority Data
Feb. 18, 2019 (JP) 2019-026773

(51) Int. Cl. H01J 49/42; H01J 49/00; H01J 49/08; H01J 49/24

(52) U.S. Cl. CPC H01J 49/422; H01J 49/24; H01J 49/08; H01J 49/0022

(57) ABSTRACT

A mass spectrometer includes: a vacuum chamber; and an ion trap and a surface emission-type electron emissive element, the ion trap and the surface emission-type electron emissive element being disposed inside the vacuum chamber.

### INCORPORATION BY REFERENCE

The disclosure of the following priority application is herein incorporated by reference: Japanese Patent Application No. 2019-026773 filed Feb. 18, 2019

### TECHNICAL FIELD

The present invention relates to a mass spectrometer.

### BACKGROUND ART

In an expensive mass spectrometer having high analysis accuracy, an ion trap is configured by a group of hyperboloid-shaped electrodes produced with high machine accuracy of micron order. A sample molecule is ionized outside the ion trap at an atmospheric pressure outside the device or in a vacuum inside the device, and the ionized sample molecule is introduced into the ion trap, trapped, and analyzed. Moreover, an expensive, high-performance turbo-molecular pump is used to prevent an adverse effect caused by residual gas

On the other hand, in an inexpensive, compact, portable mass spectrometer, an electrode of the ion trap is simplified to be a flat electrode or a cylindrical electrode, and a scroll pump or the like which is relatively inexpensive is used as an exhaust system. Accordingly, the degree of vacuum is low (the pressure inside the device is high). The NPTL1 has proposed a configuration of irradiating a sample inside an ion trap under such a condition with electrons emitted from an electron gun disposed outside the ion trap to ionize the sample.

### CITATION LIST

### Non-Patent Literature

NPTL1: Gao L, Song Q, Noll R J, Duncan J, Cooks R G, Ouyang Z. “Glow discharge electron impact ionization source for miniature mass spectrometers” Journal of mass spectrometry, (the U.K.), Wiley, May 2007, Volume 42, Issue 5, pp. 675-680

### SUMMARY OF INVENTION

### Technical Problem

However, an ion trap is required to retain ions. Thus, an introduction port for electrons is required to be small. Further, in the portable mass spectrometer, the pressure is high, and an intense electric field or a filament cannot be used. For these or other restrictions on design, the sample cannot be efficiently ionized in some cases.

### Solution to Problem

According to the 1st aspect of the present invention, a mass spectrometer comprises: a vacuum chamber; and an ion trap and a surface emission-type electron emissive element, the ion trap and the surface emission-type electron emissive element being disposed inside the vacuum chamber.

### Advantageous Effects of Invention

According to the present invention, control in mass spectrometry utilizing the characteristics of an electron emissive element can be performed. For example, a sample introduced into a vacuum chamber can be ionized efficiently without being susceptible to the pressure.

### BRIEF DESCRIPTION OF DRAWINGS

FIG. 1A is a conceptual diagram illustrating a configuration of a mass spectrometer according to an embodiment.

FIG. 1B is a conceptual diagram illustrating an ion trap.

FIG. 2 is a cross-sectional view schematically illustrating ionization by an electron emissive element.

FIG. 3 is a cross-sectional view illustrating the electron emissive element.

FIG. 4 is a flowchart illustrating steps of a method for mass spectrometry according to an embodiment.

FIG. 5 is a cross-sectional view schematically illustrating an ion trap in a Variation.

FIG. 6 is a cross-sectional view schematically illustrating a mass spectrometer of a Variation.

FIG. 7 is a flowchart illustrating steps of a method for mass spectrometry of a Variation.

### DESCRIPTION OF EMBODIMENTS

The embodiment of the present invention will be described below with reference to the drawings.

### First Embodiment

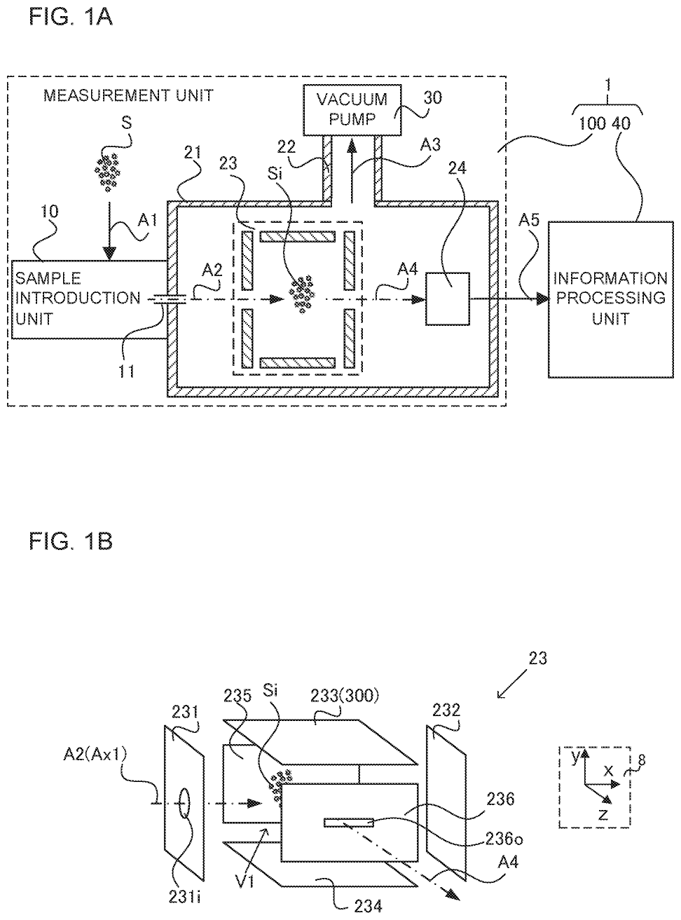

FIG. 1A is a conceptual diagram illustrating a configuration of a mass spectrometer according to the present embodiment. A mass spectrometer 1 includes a measurement unit 100 and an information processing unit 40. The measurement unit 100 includes: a sample introduction unit 10 through which a sample S is introduced into the mass spectrometer 1; a vacuum chamber 21; an exhaust port 22; an ion trap 23 for retaining sample ions Si generated by ionization of the sample S; a detection unit 24; and a vacuum pump 30.

The sample introduction unit 10 includes a sample chamber (not shown) in which the sample S is stored and a sample introduction port 11. The sample S may be in any of a gas phase, a liquid phase, and a solid phase. A user of the mass spectrometer 1 (hereinafter simply referred to as user) introduces a sample S into the sample chamber. In the case where the sample S introduced into the sample chamber is in a liquid phase or a solid phase, the sample introduction unit 10 vaporizes the sample S as required by heating with a heater (not shown) or the like to introduce the sample S into the sample introduction port 11. The introduction of the sample S into the sample introduction unit 10 by the user is schematically indicated by an arrow A1.

The sample introduction port 11 is a tube having a first end connected to the sample introduction unit 10 and a second end connected to the inside of the vacuum chamber 21 such that the sample S is movable therethrough. The introduction of the sample S into the sample introduction port 11 is controlled by opening and closing of a valve (not shown) or the like, and the sample S is moved to the inside of the vacuum chamber 21 by a difference in internal pressure between the sample introduction unit 10 and the vacuum chamber 21 and then introduced into an ion trap 23 (arrow A2).

The vacuum chamber 21 includes the ion trap 23 and a detection unit 24 inside and is connected to an exhaust port 22 such that gas inside the vacuum chamber 21 can be exhausted. The exhaust port 22 is connected to the vacuum pump 30 so as to exhaust gas. The vacuum pump 30 is a vacuum pump such as a rotary pump, a scroll pump, or a diaphragm pump. These vacuum pumps allow the mass spectrometer 1 to be compact. Thus, they are suitable in the case where the mass spectrometer 1 has portability to be carried by the user. In FIG. 1A, the exhaust of gas inside the vacuum chamber 21 is schematically indicated by an arrow A3.

The mass spectrometer 1 performs analysis in the state where the internal pressure of the vacuum chamber 21 is 0.1 Pa or more or 1 Pa or more. When conventional mass spectrometer is operated at such a pressure, it is difficult to perform efficient ionization. However, in the present embodiment, the ionization using an electron emissive element to be mentioned below is insusceptible to the pressure, and analysis thus can be suitably performed at such a pressure. When the pressure is too high, the mean free path of a electron, the sample ion Si or the like becomes short, and it becomes difficult to perform analysis. Thus, analysis is performed preferably at an internal pressure of the vacuum chamber 21 of 100 Pa or less.

From the same viewpoint, the exhaust rate of the vacuum pump 30 can be 100 L/min or less, or 60 L/min or less. Conventionally, such a vacuum pump has caused the pressure of the vacuum chamber 21 to be high, and it has been difficult to perform efficient ionization. However, in the present embodiment, ionization can be suitably performed. When the pressure is too high, the mean free path becomes too short so that it becomes difficult to perform analysis. Thus, the exhaust rate of the vacuum pump 30 is preferably 10 L/min or more, more preferably 20 L/min or more.

The mass spectrometer 1 may be operated at a pressure of less than 0.1 Pa. Or the exhaust rate of the vacuum pump 30 may be more than 100 L/min. An aspect of the vacuum exhaust system having the vacuum pump 30 is not particularly limited, and the vacuum exhaust system may be constituted by, for example, a pump capable of achieving high vacuum of 10⁻² Pa or less such as a turbo-molecular pump and an auxiliary pump thereof.

The ion trap 23 ionizes the sample S introduced into the ion trap 23 and generates sample ions Si. The ion trap 23 retains and emits the generated sample ions Si to the outside of the ion trap 23. A mass separation is performed by emitting the sample ions Si having different m/z controlled by voltages applied to the ion trap 23 at different times. The ion trap 23 will be described later in detail. The sample ions Si emitted from the ion trap 23 are introduced into a detection unit 24 (arrow A4).

The mass spectrometer 1 may further include one or more optional kind of mass analyzer in addition to the ion trap 23. A method of the mass separation utilizing the ion trap 23 is not particularly limited, and for example, in order to detect the sample ions, the mass separation may be performed using a time-of-flight mass analyzer after emitting sample ions Si from the ion trap 23 without mass separation.

The detection unit 24 includes an ion detector such as a Faraday cup and detects mass-separated sample ions Si. Data (hereinafter referred to as measurement data) on the amplitudes of detection signals obtained at the respective times are A/D converted using an A/D converter (not shown) and are thereafter output to an information processing unit 40 (arrow A5). For example, when the sample ions Si are detected by the Faraday cup, current values obtained at the respective times are converted into voltage values using a current/voltage converter (not shown) and are thereafter A/D converted into digital signals, and the digital signals are output.

The information processing unit 40 includes an information processing device such as a personal computer (hereinafter referred to as PC). The information processing unit 40 performs control of the measurement unit 100, analysis of the measurement data, and the like using a processor including CPU and the like. The method of the analysis of the measurement data is not particularly limited, and the information processing unit 40 can create data corresponding to a mass spectrum and can calculate the amount of molecules having a specific m/z in the sample S or the like on the basis of the amplitude of the detected signal corresponding to the m/z. The information processing unit 40 includes an input device such as a mouse, a keyboard, and a touch panel, and the processor receives input from the user via the input device. The information processing unit 40 further includes a display device such as a liquid crystal monitor and displays information obtained by the analysis and the like on the display device.

The information processing unit 40 may be configured as a single device integrated with the measurement unit 100.

Configuration of Ion Trap 23

FIG. 1B is a perspective view schematically illustrating an ion trap 23. An axis along an incident direction for the sample ion Si is set to be an x axis, an axis along an emission direction for the sample ion Si perpendicular to the incident direction is set to be a z axis, and an axis perpendicular to the x and z axes is set to be a y axis (see coordinate axes 8).

The ion trap 23 includes a first electrode 231, a second electrode 232, a third electrode 233, a fourth electrode 234, a fifth electrode 235, and a sixth electrode 236, each having a plate-like shape. The first electrode 231 and the second electrode 232 are disposed to face each other in substantially parallel to the yz plane. The third electrode 233 and the fourth electrode 234 are disposed to face each other in substantially parallel to the zx plane. The fifth electrode 235 and the sixth electrode 236 are disposed to face each other in substantially parallel to the xy plane.

The sample ions Si are retained in an inner space V1 surrounded by the first electrode 231, the second electrode 232, the third electrode 233, the fourth electrode 234, the fifth electrode 235, and the sixth electrode 236. A direct-current voltage is applied from a direct-current power supply (not shown) to the first electrode 231 and the second electrode 232. This direct-current voltage is set to be a voltage that is, for example, several tens of volts higher than an average voltage of voltages of the third electrode 233, the fourth electrode 234, the fifth electrode 235, and the sixth electrode 236 in the case where the sample ions Si to be detected are cations. This direct-current voltage is set to be a voltage that is, for example, several tens of volts lower than the above-mentioned average voltage in the case where the sample ions Si to be detected are anions. Accordingly, the first electrode 231 and the second electrode 232 function as pushing back electrodes for causing the sample ions Si to be easily retained in a space V1.

An alternating-current voltage is applied from an alternating-current power supply (not shown) to the third electrode 233, the fourth electrode 234, the fifth electrode 235, and the sixth electrode 236. The sample ions Si are periodically moved in the space V by this alternating-current voltage. The amplitude and the phase of the voltage applied to each electrode are adjusted so as to retain the sample ions Si by their periodical move in the space V1. For example, the distance between the third electrode 233 and the fourth electrode 234 facing each other and the distance between the fifth electrode 235 and the sixth electrode 236 facing each other can be set to 6 to 12 mm or the like, the frequency of the alternating-current voltage to be applied can be set to 0.5 to 10 MHz, and the amplitude of this alternating-current voltage can be set to 500 V to 2 kV or the like.

The third electrode 233 is configured by including a plate-like electron emissive element 300 for emitting electrons. The configuration of the electron emissive element 300 will be described later. The sample S introduced from the sample introduction unit 10 into the vacuum chamber 21 passes through an opening 231i formed in the first electrode 231 and is then introduced into the ion trap 23 (arrow A2). The sample S introduced into the ion trap 23 is irradiated with the electrons emitted from the electron emissive element 300 and becomes the sample ions Si. The sample ions Si are emitted from a slit 236o formed in the sixth electrode 236 by applying a voltage having a polarity opposite to a polarity of the sample ions Si to the sixth electrode 236 or the like (arrow A4).

The aspect and the position of the opening for introducing the sample ions Si to the ion trap 23 or for emitting the sample ions Si from the ion trap 23 is not particularly limited. For example, the slit 236o can be disposed in the second electrode 232, the fourth electrode 234, the fifth electrode 235, or the like.

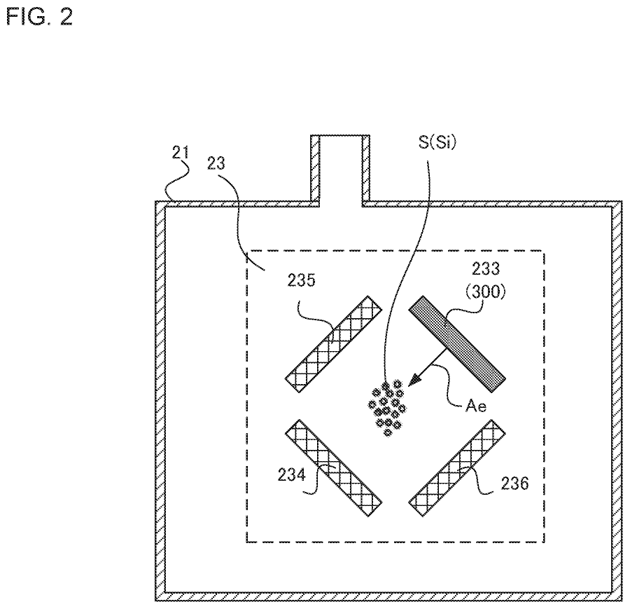

FIG. 2 is a cross-sectional view of the vacuum chamber 21 schematically illustrating ionization by the electron emissive element 300. FIG. 2 shows a third electrode 233, a fourth electrode 234, a fifth electrode 235, and a sixth electrode 236 among electrodes that constitute an ion trap 23 and does not show a first electrode 231 and a second electrode 232. A sample S introduced into the ion trap 23 of the vacuum chamber 21 is irradiated with electrons emitted from an electron emissive element 300 that constitutes the third electrode 233 of the ion trap 23. Molecules contained in the sample S are ionized by collisions between the electrons accelerated in the electron acceleration layer 320 to be described later and the molecules. In a conventional method in which electrons are introduced into an ion trap from the outside of the ion trap through an introduction port, efficiency of ionization is restricted by the size of the introduction port and the like in some cases. In contract, the method for ionization according to the present embodiment does not involve such a restriction.

Configuration of Electron Emissive Element

The electron emissive element 300 is a surface emission-type electron emissive element that emits electrons accelerated inside the electron emissive element 300 from the surface.

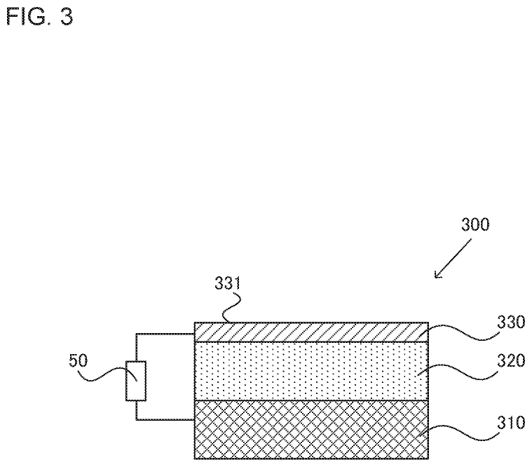

FIG. 3 is a cross-sectional view schematically illustrating a configuration of the electron emissive element 300. The electron emissive element 300 includes a substrate electrode 310, an electron acceleration layer 320, and an emission surface side electrode 330. The electron emission element 300 has a plate-like shape where an electron emission surface 331 is used as a principal surface, and a layer of the emission surface side electrode 330, the electron acceleration layer 320, and a layer of the substrate electrode 310 are formed in order from the side of electron emission surface 331.

The mass spectrometer 1 is not required to have analysis accuracy as high as the mass spectrometer operated in a high vacuum made by a turbo-molecular pump or the like. Thus, the mass spectrometer 1 is less affected by the configuration where the ion trap 23 includes plate-like electrodes. Accordingly, also from this point of view, a plate-like electron emissive element 300 is suitable for the mass spectrometer 1.

The substrate electrode 310 is a plate-like layer containing a substance having conductivity such as metal. The substrate electrode 310 is composed of, for example, a stainless substrate.

The electron acceleration layer 320 is a plate-like layer containing an insulator and a conductive material dispersed inside the insulator. The thickness of the electron acceleration layer 320 can be adjusted appropriately by a voltage to be applied to the substrate electrode 310 or the emission surface side electrode 330 with respect to the other and the resistance of the electron acceleration layer 320. The resistance of the electron acceleration layer 320 can be adjusted by changing the proportion of the conductive material in the insulator and the like.

In an example of the electron acceleration layer 320, a silicone resin obtained by condensation polymerization of a compound where a hydroxy group is bonded directly to silicon (R3Si—OH) (where Si represents silicon) among silicon compounds is used as the insulator, and fine particles of a metal such as gold, silver, platinum, or palladium are used as the conductive material. The average diameter of the metal fine particles can be 5 nm to 10 nm or the like. The thickness of the electron acceleration layer can be 0.3 to 2.0 μm or the like.

The emission surface side electrode 330 is a plate-like layer containing a material having conductivity, and this material is not particularly limited as long as a voltage for accelerating electrons can be applied. In order to cause electrons to efficiently transmit therethrough, the emission surface side electrode 330 is preferably thinner under the condition where the voltage can be applied. The thickness of the emission surface side electrode 330 can be, for example, several tens of nanometers or the like.

The electron emissive element 300 emits electrons accelerated in the electron acceleration layer 320 inside the element. Thus, it is not required to heat a filament at a high temperature to generate thermoelectrons nor to form an intense electric field outside the element such as in the case of field electron emission. Accordingly, a filament is not burned out by oxidation, and the element is not damaged by cations and ozone generated by the intense electric field, and ionization can be performed suitably under the pressure of 0.1 Pa or more.

Suitable examples of the electron emissive element 300 include those described in JP 2014-7128 A or a paper, Iwamatsu et. al., (Iwamatsu T, Hirakawa H, Yamamoto H. “Novel Charging System by Electron Emission Device in the Atmosphere” NIHON GAZO GAKKAISHI (Journal of the Imaging Society of Japan, (Japan), The Imaging Society of Japan, January 2017, Volume 56, Issue 1, pp. 16-23).

In the electron emissive element 300, a voltage is applied to the emission surface side electrode 330 to control ions inside the ion trap 23 as mentioned above, and in addition, a voltage is applied to the substrate electrode 310 or the emission surface side electrode 330 with respect to the other to emit electrons by a voltage application unit 50 composed of a voltage power supply. This voltage may be a direct-current voltage or an alternating-current voltage. The voltage application unit 50 applies the voltage such that the voltage of the emission surface side electrode 330 becomes +several volts to +several tens of volts or the like, for example, with respect to the substrate electrode 310. Accordingly, electrons can be emitted from the electron emissive element 300, and the sample S can be ionized by collisions between emitted electrons and the sample S.

Method for Manufacturing Electron Emissive Element

For example, in the case where the insulator of the electron acceleration layer 320 is a silicone resin, and the conductive material of the electron acceleration layer 320 is silver fine particles, the electron emissive element 300 can be manufactured in the following method. A toluene solvent containing silver fine particles having an average diameter of 5 nm or the like dispersed therein is dispersed in a silicone resin. Thus, a dispersion liquid is obtained. This dispersion liquid is applied to a substrate electrode 310 to have a thickness of 1 μm or the like by a spin coating method, a doctor brade method, a spraying method, a dipping method, or the like to form a film. Thus, an electron acceleration layer 320 is formed. A thin film of a gold electrode having a thickness of 20 to 40 nm or the like is formed on the formed electron acceleration layer 320 by a sputtering method.

Mass Spectrometry

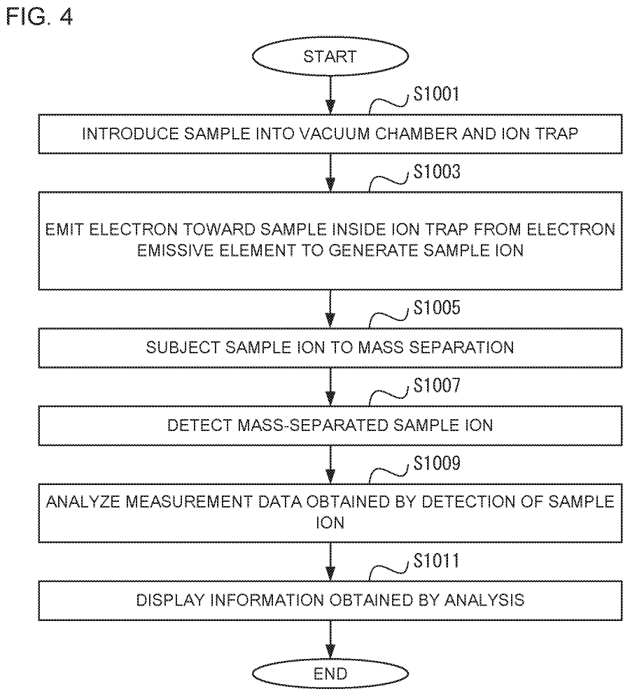

FIG. 4 is a flowchart illustrating steps of a method for mass spectrometry according to the present embodiment. This method for mass spectrometry is performed by the processor of the information processing unit 40. In the step S1001, the sample introduction unit 10 introduces the sample S into the vacuum chamber 21 and the ion trap 23. After the step S1001, the step S1003 is started.

In the step S1003, the electron emissive element 300 emits electrons toward the sample S inside the ion trap 23 to generate the sample ions Si. After the step S1003, the step S1005 is started. In the step S1005, the ion trap 23 subjects the generated sample ions Si to mass separation. After the step S1005, the step S1007 is started.

In the step S1007, a detection unit 24 detects the mass-separated sample ions Si. After the step S1007, the step S1009 is started. In the step S1009, the information processing unit 40 analyzes measurement data obtained by detection of the sample ions Si. After the step S1009, the step S1011 is started.

In the step S1011, the information processing unit 40 displays information obtained by the analysis of the measurement data on the display device (not shown). After the step S1011, the process is completed.

The following Variations are also within the scope of the present invention and can be combined with the embodiment described above. In the following Variations, parts having the same structures or functions as those of the above-mentioned embodiment are denoted by the same reference numerals, and the descriptions of the parts are omitted as appropriate.

Variation 1.

In the the above-mentioned embodiment, the mass spectrometer 1 is configured such that the sample S is introduced from the sample introduction unit 10 to the vacuum chamber 21 and the ion trap 23. However, the mass spectrometer 1 may be configured such that a sample eluted from a chromatograph such as a gas chromatograph is introduced into the ion trap 23. In this case, the mass spectrometer 1 can be a mass spectrometer including a chromatograph such as a gas chromatograph-mass spectrometer (GC-MS) or the like. Accordingly, the sample can be separated more precisely by a separation using a chromatograph and a mass separation, and analysis can be performed more accurately.

Variation 2

In the above-described embodiment, a Metal-Insulator-Semiconductor (MIS) type or a Metal-Insulator-Metal (MIM) type element may be used as the surface emission-type electron emissive element. As to these elements, electrons accelerated in an electron acceleration layer inside each element are emitted. Accordingly, burning out of the hot filament for generating thermoelectrons and damage to the element by cations and ozone generated by the intense electric field for field electron emission can be prevented even under the pressure of 0.1 Pa or more. Accordingly, ionization can be suitably performed under the pressure of 0.1 Pa or more.

Variation 3

In the above-mentioned embodiment, among electrodes that constitute an ion trap 23, a third electrode 233 is constituted by an electron emissive element 300. However, the aspect of the placement and the number of the electron emissive elements 300 are not particularly limited as long as it faces the space V inside the ion trap 23. For example, at least one of the first electrode 231, the second electrode 232, the third electrode 233, the fourth electrode 234, the fifth electrode 235, and the sixth electrode 236 can be constituted by the electron emissive element 300.

Variation 4

In the above-mentioned embodiment, the ion trap 23 is constituted by plate-like electrodes. However, the ion trap 23 may be a three-dimensional ion trap.

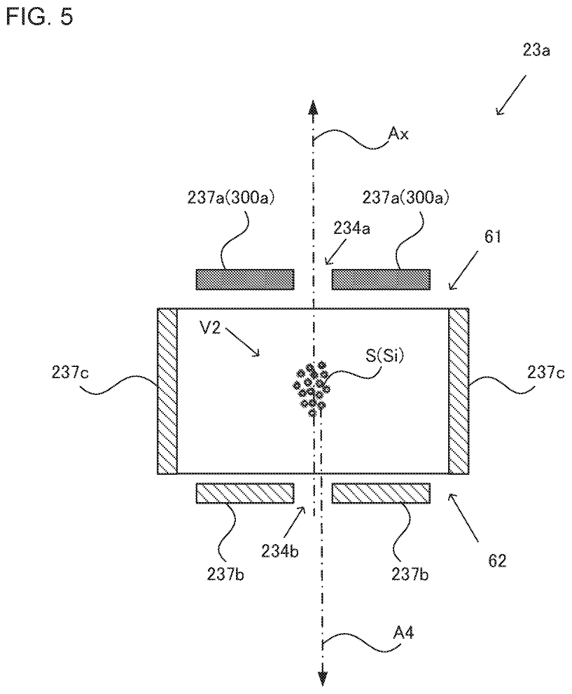

FIG. 5 is a conceptual diagram illustrating an ion trap 23a of the present Variation. The ion trap 23a includes an upper electrode 237a, a lower electrode 237b, and a cylindrical electrode 237c, and sample ions Si are retained in an inner space V2 surrounded by these electrodes. The ion trap 23a is rotationally symmetric to an axis Ax.

The upper electrode 237a is disposed on the upper side of the space V2, has a disc-like shape having an opening 234a at the center, and is constituted by the electron emissive element 300a. The electron emissive element 300a has the same three-layer structure as in the electron emissive element 300 and is formed to have a disc-like shape having an opening 234a. The lower electrode 237b is disposed on the lower side of the space V2 and has a disc-like shape having an opening 234b at the center. The cylindrical electrode 237c is disposed to be substantially parallel to the rotation axis Ax and has a hollow cylindrical shape.

A sample S is introduced into the ion trap 23a from a gap 61 between the upper electrode 237a and the cylindrical electrode 237c or a gap 62 between the lower electrode 237b and the cylindrical electrode 237c. The introduced sample S is ionized by electrons emitted from the electron emissive element 300a that constitutes the upper electrode 237a, and sample ions Si are thus generated. The sample ions Si are retained in the space V2 by a direct-current voltage applied to the upper electrode 237a and the lower electrode 237b and an alternating-current voltage applied to the cylindrical electrode 237c. The sample ions Si are emitted from the opening 234b by applying a voltage having a polarity opposite to a polarity of the sample ions Si to the lower electrode 237b or the like (arrow A4).

The electron emissive element 300a may be disposed in the lower electrode 237b. The positions of an introduction port and an emission port for the sample ions Si are not particularly limited, and for example, the opening 234a or an opening (not shown) formed in the cylindrical electrode 237c can be the emission port.

Variation 5

In the above-mentioned embodiment, the mass spectrometer is configured such that the sample S is ionized inside the ion trap 23. However, the mass spectrometer may be configured such that the sample S is irradiated with electrons emitted from the electron emissive element in a path from the sample introduction unit 10 to the ion trap.

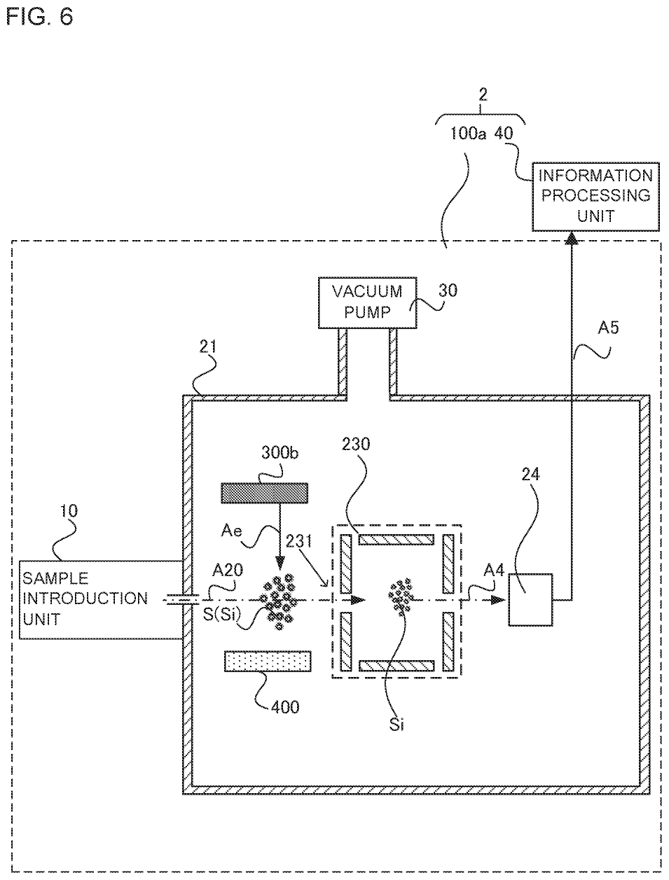

FIG. 6 is a cross-sectional view schematically illustrating a mass spectrometer 2 according to the present Variation. The mass spectrometer 2 includes a measurement unit 100a and an information processing unit 40. The measurement unit 100a includes: a sample introduction unit 10; an ion trap 230; an electron emissive element 300b and a counter electrode 400 disposed inside the vacuum chamber 21 and outside the ion trap 230; and a detection unit 24.

The ion trap 230 includes an ion introduction port 231. The configuration of the ion trap 230 is not particularly limited as long as it can control introduction, retention, mass separation, and discharge of ions. The ion trap 230 may or may not include an electron emissive element.

The electron emissive element 300b has the same configuration as the electron emissive element 300 except that a voltage for controlling ions is not applied and is disposed to face the path (arrow A20) from the sample introduction unit 10 to the ion trap 230. The counter electrode 400 is disposed to face the electron emissive element 300b across the path (arrow A20), and a predetermined voltage is applied from a voltage power supply (not shown) to the counter electrode 400. This predetermined voltage accelerates electrons emitted from the electron emissive element 300b and thus is set to be a voltage that is several to several tens of volts higher than the voltage of the emission surface side electrode 330 (FIG. 3) of the electron emissive element 300b.

The sample S introduced from the sample introduction unit 10 is irradiated (arrow Ae) with electrons emitted from the electron emissive element 300b on the way in the above-described path (arrow A20) and ionized to generate sample ions Si. The generated sample ions Si are introduced into the ion trap 230 from the ion introduction port 231, subjected to a mass separation, discharged (arrow A4), and detected by the detection unit 24. Measurement data detected by this detection are input to an information processing unit 40 (arrow A5).

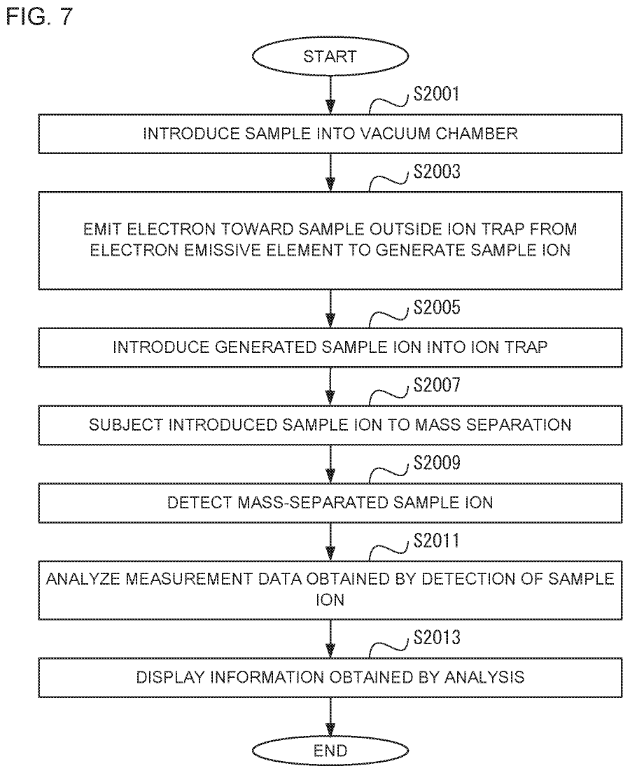

FIG. 7 is a flowchart illustrating steps of a method for mass spectrometry according to the present Variation. This method for mass spectrometry is performed by the processor of the information processing unit 40. In the step S2001, the sample introduction unit 10 introduces a sample S into a vacuum chamber 21. After the step S2001, the step S2003 is started.

In the step S2003, the electron emissive element 300b emits electrons toward the sample S outside the ion trap 230 to generate sample ions Si. After the step S2003, the step S2005 is started. In the step S2005, the ion introduction port 231 introduces the generated sample ions Si into the ion trap 230. After the step S2005, the step S2007 is started.

In the step S2007, the ion trap 230 detects mass-separated sample ions Si. After the step S2007, the step S2009 is started. The steps S2009 to S2013 are the same as the steps S1007 to S1011 in the flowchart of FIG. 4, respectively, and the description thereof are thus omitted. After the step S2013, the process is completed.

Aspects

It will be understood by a person skilled in the art that the above-described exemplary embodiments are specific examples of the following aspects.

First Item

A mass spectrometer according to an aspect can comprise a vacuum chamber; and an ion trap and a surface emission-type electron emissive element, the ion trap and the surface emission-type electron emissive element being disposed inside the vacuum chamber. Accordingly, control utilizing the characteristics of an electron emissive element can be performed. For example, the sample S introduced into a vacuum chamber 21 can be ionized efficiently without being susceptible to the pressure.

Second Item

A mass spectrometer according to another aspect is configured such that in the mass spectrometer according to the aspect of the first item, the sample introduced into the vacuum chamber may be irradiated with an electron emitted from the electron emissive element so as to ionize the sample. Accordingly, efficient ionization of the sample S introduced into the vacuum chamber 21 without being susceptible to the pressure can be performed.

Third Item A mass spectrometer according to yet another aspect is configured such that in the mass spectrometer according to the aspect of the second item, the electron emissive element may be disposed outside the ion trap, and the sample may be irradiated with an electron emitted from the electron emissive element outside the ion trap. Accordingly, efficient ionization of the sample S can be performed without any restriction on design of the ion trap.

Fourth Item

A mass spectrometer according to yet another aspect is configured such that in the mass spectrometer according to the aspect of the first or second item, the electron emissive element can constitute at least a part of electrodes in the ion trap. Accordingly, efficient ionization can be performed without the requirement of providing an introduction port for electrons in the ion trap, restriction on ionization by the size of the introduction port, and the like. Further, the number of parts for manufacturing can be reduced.

Fifth Item

A mass spectrometer according to yet another aspect is configured such that in the mass spectrometer according to any one of the aspects of the first to fourth items, the ion trap may be configured to comprise a plate-like electrode. Accordingly, the manufacturing is facilitated, and the electron emissive element can be easily incorporated as an electrode.

Sixth Item

A mass spectrometer according to yet another aspect is configured such that in the mass spectrometer according to any one of the aspects of the first to fifth items, the internal pressure of the vacuum chamber can be 0.1 Pa or more. In such a mass spectrometer, an ion source is easily damaged by using an intense electric field or a filament, and efficient ionization cannot be performed easily. However, efficient ionization can be achieved by the method according to the above-described embodiment.

Seventh Item

A mass spectrometer according to yet another aspect is configured such that the mass spectrometer according to any one of the aspects of the first to sixth items can comprise a rotary pump, a scroll pump, or a diaphragm pump connected to the vacuum chamber so as to be capable of exhausting gas. Accordingly, a compact or portable mass spectrometer can be achieved.

The present invention is not limited by the embodiments. Other aspects conceivable within the scope of the technical idea of the present invention are encompassed in the scope of the present invention.

### REFERENCE SIGNS LIST

1, 2: mass spectrometer, 10: sample introduction portion, 11: sample introduction port, 21: vacuum chamber, 22: exhaust port, 23, 23a, 230: ion trap, 24: detection unit, 30: vacuum pump, 40: information processing unit, 50: voltage application unit, 100, 100a: measurement unit, 231: first electrode, 231a, 234a, 234b: opening, 232: second electrode, 233: third electrode, 234: fourth electrode, 235: fifth electrode, 236: sixth electrode, 236o: slit, 300, 300a, 300b: electron emissive element, 310: substrate electrode, 320: electron acceleration layer, 330: emission surface side electrode, 331: electron emission surface, 400: counter electrode, S: sample, Si: sample ion

1. A mass spectrometer comprising:
a vacuum chamber; and
an ion trap and a surface emission-type electron emissive element, the ion trap and the surface emission-type electron emissive element being disposed inside the vacuum chamber.

2. The mass spectrometer according to claim 1, wherein:
a sample introduced into the vacuum chamber is irradiated with an electron emitted from the electron emissive element so as to ionize the sample.

3. The mass spectrometer according to claim 2, wherein:
the electron emissive element is disposed outside the ion trap, and
the sample is irradiated with an electron emitted from the electron emissive element outside the ion trap.

4. The mass spectrometer according to claim 1, wherein:
the electron emissive element constitutes at least a part of electrodes of the ion trap.

5. The mass spectrometer according to claim 2, wherein:
the electron emissive element constitutes at least a part of electrodes of the ion trap.

6. The mass spectrometer according to claim 1, wherein:
the ion trap is configured to comprise a plate-like electrode.

7. The mass spectrometer according to claim 2, wherein:
the ion trap is configured to comprise a plate-like electrode.

8. The mass spectrometer according to claim 3, wherein:
the ion trap is configured to comprise a plate-like electrode.

9. The mass spectrometer according to claim 4, wherein:
the ion trap is configured to comprise a plate-like electrode.

10. The mass spectrometer according to claim 5, wherein:
the ion trap is configured to comprise a plate-like electrode.

11. The mass spectrometer according to claim 1, wherein:
an internal pressure of the vacuum chamber is 0.1 Pa or more.

12. The mass spectrometer according to claim 1, comprising:
a rotary pump, a scroll pump, or a diaphragm pump connected to the vacuum chamber so as to be capable of exhausting gas.
